(19) United States
(12) Patent Application Publication
(10) Pub. No.: US 2008/0099587 A1
(43) Pub. Date: May 1, 2008

(54) Nozzle device for a spray gun

(76) Inventor: Jui-min Chiang, Shin Chuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/898,381

(22) Filed: Sep. 12, 2007

(30) Foreign Application Priority Data
Oct. 27, 2006 (TW) 095219048

(51) Int. Cl. B05B 1/00

(52) U.S. Cl. 239/600

(57) ABSTRACT

A nozzle device for a spray gun includes a nozzle base, a clip, a securing member and a releasing member. The securing member is to hold the clip in a locked position. The releasing member is to release the clip from a locked position.

### BACKGROUND OF THE INVENTION

1. Field of the Invention

The present invention relates to a nozzle device for a pray gun, and more particularly to a nozzle device that is easy to secure and release a nozzle on a spray gun.

2. Description of the Prior Art

A pray gun having a nozzle board to spray paint with various particles are widely used on the market. The nozzle board is provided with different nozzles, 4.5 mm, 6 mm and 8 mm in diameter, to change the output paint size as well as shape. As shown in FIG. 5, a conventional nozzle device comprises a nozzle base 51 disposed on an outlet 21 of a spray gun 20, a clip 52 and a releasing member 53. The nozzle base 51 has a trough 511 adapted to receive a nozzle board 30 therein. An engaging section 512 is formed at the bottom of the nozzle base 51. The clip 52 is shaped like an English capital letter U. The clip 52 has an open end 521 and a locking section 522. The open end 521 is pivotally connected to the top of the nozzle base 51. The locking section 522 is adapted to engage with the engaging section 512. The releasing member 53 is shaped like an English capital letter U. The releasing member 53 has an open end 531. The open end 531 is pivotally connected to the bottom of the nozzle base 51. The middle portion of the releasing member 53 is contact with the locking section 522 of the clip 52.

By pulling the releasing member 53, the locking section 522 of the clip 52 can be detached from the engaging section 512, so that the nozzle board 30 is free to move.

The releasing process of the above mentioned design is convenient. However, the user has to try hard to push the locking section 522 of the clip 52 to engage with the engaging section 512.

### SUMMARY OF THE INVENTION

According to the present invention, there is provided a nozzle device for a spray gun, comprising a nozzle base disposed at the front of the spray gun, said nozzle base having a trough to receive a nozzle board therein, an engaging section being formed at the bottom of said nozzle base; a clip shaped like an English capital letter U, said clip having an open end and a locking section, said open end being pivotally connected to the top of said nozzle base, said locking section being adapted to engage with said engaging section of said nozzle base; a securing member shaped like an English capital letter U, said securing member having an open end and a closed end, said open end being pivotally connected to the bottom of said nozzle base, said closed end passing through said locking section of said clip, said securing member having a middle portion contacting with a front edge of said locking section of said clip; and a releasing member shaped like an English capital letter U, said releasing member having an open end and a closed end, said open end being pivotally connected to the bottom of said nozzle base behind said securing member, said releasing member having a middle portion contacting with a rear edge of said locking section of said clip.

It is the primary object of the present invention to provide a nozzle device for a spray gun, which is easy to lock and to release a nozzle board.

It is another object of the present invention to provide a nozzle device for a spray gun, which is easy to replace the nozzle board.

### BRIEF DESCRIPTION OF THE DRAWINGS

FIG. 1 is an exploded view of a preferred embodiment of the present invention;

FIG. 2 is a perspective view of the preferred embodiment of the present invention;

FIG. 3 is a side view of the preferred embodiment of the present invention in a locked position;

FIG. 4 is a side view of the preferred embodiment of the present invention in an unlocked position; and

FIG. 5 is a side view of the prior art.

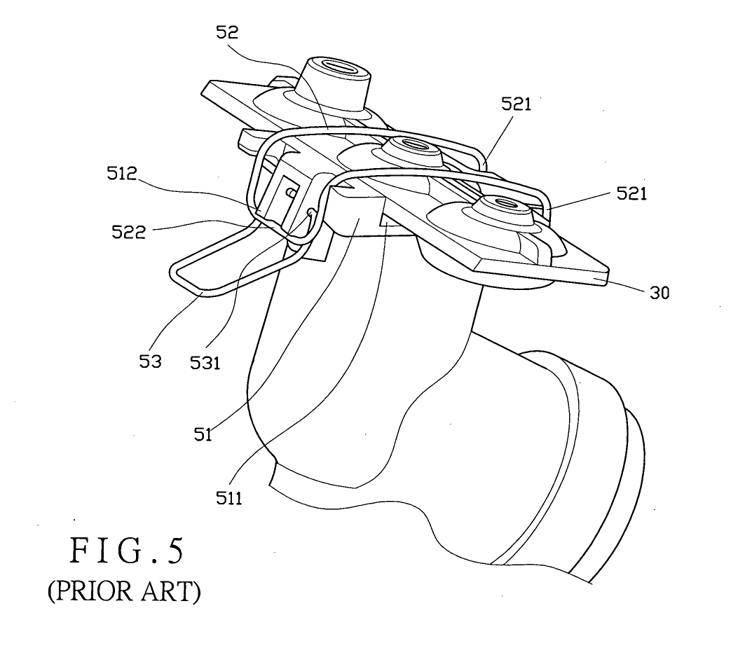

### DETAILED DESCRIPTION OF THE PREFERRED EMBODIMENT

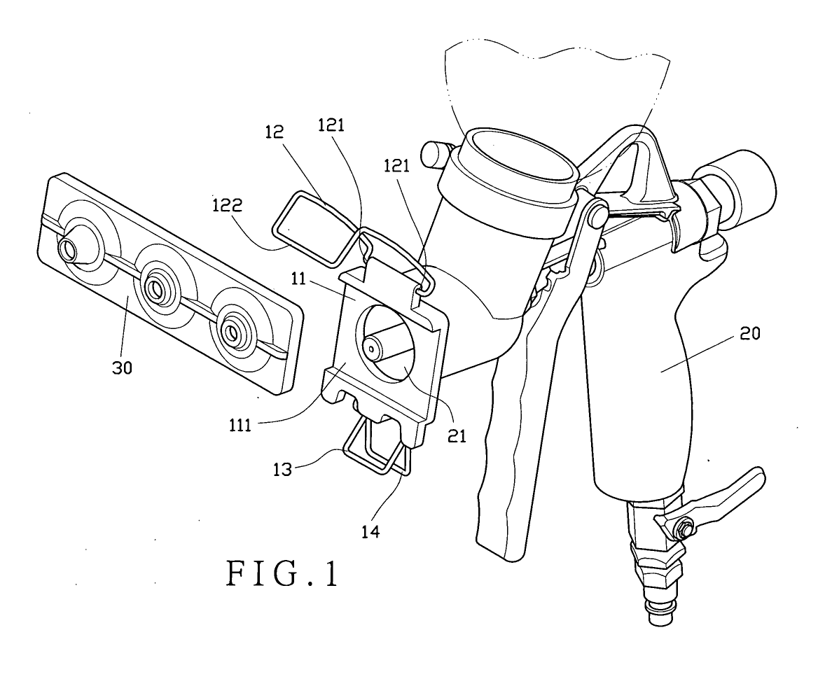

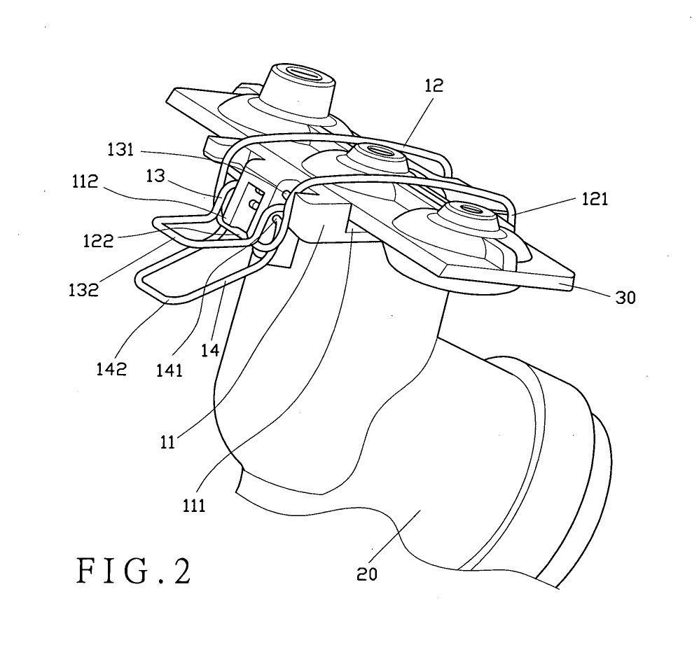

As shown in FIGS. 1 and 2, a preferred embodiment of the present invention comprises a nozzle base 11, a clip 12, a securing member 13 and a releasing member 14. The clip 12, the securing member 13 and the releasing member 14 are shaped like an English capital letter U.

The nozzle base 11 is disposed on an outlet 21 at the front of a spray gun 20. The nozzle base 11 has a trough 111 to receive a nozzle board 30 therein. An engaging section 112 is formed at the bottom of the nozzle base 11.

The clip 12 has an open end 121 and a locking section 122 bending rearward. The open end 121 is pivotally connected to the top of the nozzle base 11. The locking section 122 is adapted to engage with the engaging section 112 of the nozzle base 11.

The securing member 13 has an open end 131 and a closed end 132. The open end 131 is pivotally connected to the bottom of the nozzle base 11, while the closed end 132 passes through the locking section 122 of the clip 12. The securing member 13 has its middle portion contacting with a front edge of locking section 122 of the clip 12.

The releasing member 14 has an open end 141 and a closed end 142. The open end 141 is pivotally connected to the bottom of the nozzle base 11 behind the securing member 13. The securing member 14 has its middle portion contacting with a rear edge of the locking section 122 of the clip 12.

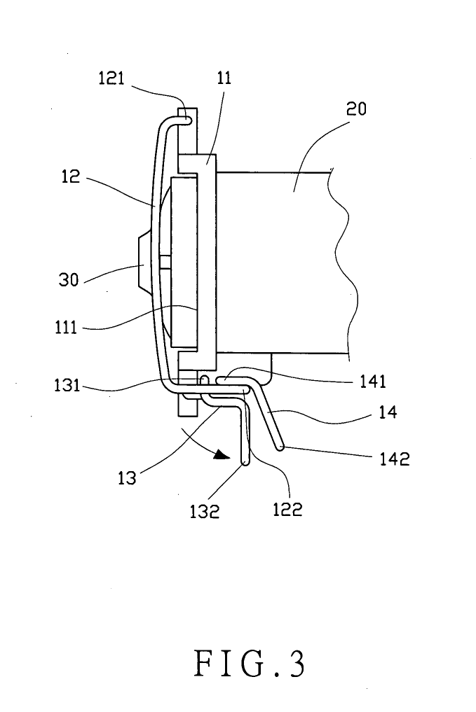

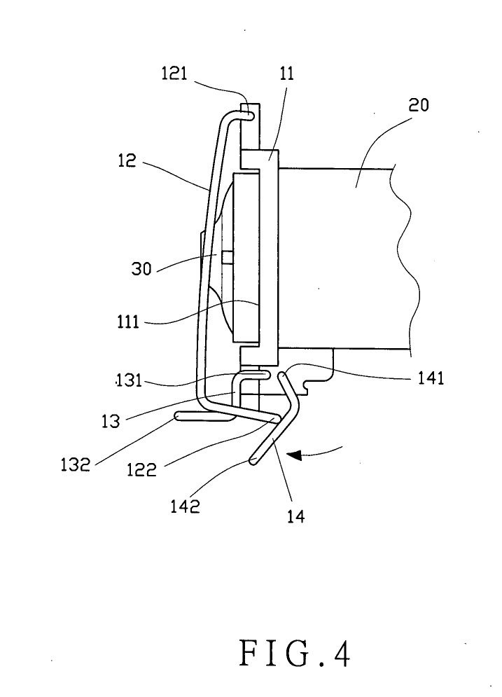

When the closed end 132 of the securing member 13 is pushed downward and rearward, the locking section 122 of the clip 12 will be engaged with the engaging section 112 of the nozzle base 11, as shown in FIG. 3. When the closed end 142 of the releasing member 14 is pushed forward and upward, the locking section 122 of the clip 12 will be disengaged from the engaging section 112 of the nozzle base 11, as shown in FIG. 4, so that the nozzle board 30 is free to move.

What is claimed is:

1. A nozzle device for a spray gun, comprising:
a nozzle base disposed at the front of the spray gun, said nozzle base having a trough to receive a nozzle board therein, an engaging section being formed at the bottom of said nozzle base;
a clip shaped like an English capital letter U, said clip having an open end and a locking section, said open end being pivotally connected to the top of said nozzle base, said locking section being adapted to engage with said engaging section of said nozzle base;
a securing member shaped like an English capital letter U, said securing member having an open end and a closed end, said open end being pivotally connected to the bottom of said nozzle base, said closed end passing through said locking section of said clip, said securing member having a middle portion contacting with a front edge of said locking section of said clip; and
a releasing member shaped like an English capital letter U, said releasing member having an open end and a closed end, said open end being pivotally connected to the bottom of said nozzle base behind said securing member, said releasing member having a middle portion contacting with a rear edge of said locking section of said clip.
